(19) United States
(12) Patent Application Publication
(10) Pub. No.: US 2007/0275802 A1
(43) Pub. Date: Nov. 29, 2007

(54) Drive For (Semi-) Continuous Drives Having An Endless Belt

(75) Inventor: Theodorus Gerhardus Potma, Rietbergstraat (NL)

Correspondence Address: YOUNG & THOMPSON, 745 SOUTH 23RD STREET, 2ND FLOOR, ARLINGTON, VA, 22202, US

(73) Assignee: T. Potma Beheer B.V., Zutphen (NL)

(21) Appl. No.: 10/593,311

(22) PCT Filed: Mar. 18, 2005
(86) PCT No.: PCT/NL05/00209

§ 371 Date: Sep. 18, 2006

(30) Foreign Application Priority Data
Mar. 18, 2004 (NL) 1025758

(51) Int. Cl. F16H 7/00

(52) U.S. Cl. 474/101; 474/148; 474/162; 474/163; 474/167

(57) ABSTRACT

Drive for continuous drives having an endless belt. The invention relates to the transmission of mechanic power from a driving pulley to a driven pulley using an endless belt, wherein the driving force is transmitted by friction between the belt and the pulleys. The driving belt is wound a few times around the pulleys as a result of which the contact angle is much larger than the usual contact angle of approximately 180 to 360 degrees at a maximum. As a result thereof the necessary tension in the low-tension part of the belt is very low whereas a very high circumferential force can nevertheless be transmitted. In this drive according to the invention there are means present due to which the belt moves axially over the pulley with little friction, as a result of which the wound part of the belt in absolute sense remains in its place. Due to the low belt pre-tension and the high belt force to be transmitted, the drive is highly suitable for continuous variable transmissions for various applications.

The invention relates to the transmission of mechanical power from a driving shaft to a driven shaft by means of an endless belt, cord, band or the like and the accompanying pulleys. It regards drives having at least two pulleys at least one of the pulleys not being provided with teeth that suit teeth of the accompanying belt, but belt drives wherein for at least one pulley applies that the driving force is transmitted by friction.

As regards the latter, drives having a flat belt and a so-called V-belt are known. In these drives a circumferential force is transmitted to the belt due to friction between the material of the driving pulley and the material of the belt. In case of the driven pulley a circumferential force is transmitted from the belt to the driven pulley in a similar way. Said circumferential force is transmitted at the location of the contact surface where the belt contacts the contact surface of the pulley.

Said circumferential force depends on the frictional coefficient between belt material and pulley material, the normal force with which these materials are pressed onto each other and the so-call ed contact angle or the angle at which the belt contacts the circumference of the pulley. In this case it applies that the maximum circumferential force, which, under otherwise similar circumstances, can be transmitted, is larger in case of a larger contact angle. Said contact angle in the known drives with an endless belt and two or more pulleys is smaller than 360 degrees.

Drives in which the circumferential force is transmitted by friction have, compared to drives in which the circumferential force is transmitted by accurately fitting teeth of belt and pulley, the advantage that the circumference of the pulley and thus the transmission ratio of the drive can be continuously variably varied. However, the drawback on the other hand is that in reality it is more difficult in this way to transmit a high circumferential force through friction.

### SUMMARY OF THE INVENTION

It is an object of the invention to provide a drive with endless belt, particularly suitable for semi-continuous or continuous transmission of power that has been improved on at least this point.

From a first aspect the invention provides a drive wherein mechanically intermittent or continuous power is transmitted from a driving shaft to a driven shaft by means of an endless belt and at least one pulley, wherein mechanic power is transmitted between belt and pulley by means of friction, wherein on said pulley the incoming part and the outgoing part of the belt are axially spaced apart. In this way room is provided for a larger contact angle of the belt on the pulley. The belt may thus assume a contact angle on the said pulley that is larger than 360 degrees of angle.

In a further development of the drive according to the invention the said pulley is provided with one or more contact or engagement surfaces for the belt that are movable in a direction comprising an axial directional component of the pulley. Because the surface of the pulley over which the belt contacts comprises one or more surfaces that are movable in axial direction with respect to the pulley, the drive belt wound around the pulley is able to move axially over the pulley with little friction and as a result low energy loss and little wear.

Advantageously the drive may be provided with means due to which the frictional coefficient between belt and pulley can be larger in tangential direction than in axial direction.

In one embodiment the contact or engagement surfaces are movable in axial direction of the pulley, therefore parallel thereto.

In an alternative embodiment the contact or engagement surfaces are movable according to a direction that is at a small angle a to the pulley shaft, preferably 20 degrees at a maximum. It is advantageous in that case when the incoming part of the belt is at an angle of (90-a) degrees to the line of movement of the contact or engagement surfaces. The movement direction may, considered in a related tangential plane, be at a small angle a to a line that is parallel to the pulley centre line.

The engagement surfaces of the pulley can be positioned in many ways. In one embodiment they are positioned according to a cylindrical body of revolution that may or may not be interrupted in circumferential direction.

In another embodiment the engagement surfaces of the pulley are positioned according to a path that is at an angle, preferably a constant acute angle, to the shaft, considered in a plane of longitudinal-section of the pulley.

The axially movable surface(s) (parts) can be grouped in axial guide beams or axial guides, wherein the surface(s) (parts) are movable parallel to the shaft of the pulley (or in case of the said small angle a, in corresponding slanted direction), wherein the axial guide beams are distributed over the circumference. Said axial guides can be radially movable in order to thus cause a change of diameter of the pulley.

The pulley according to the invention may be provided on the driving shaft as well as on the driven shaft, or on both.

In a further embodiment of the drive according to the invention the contact or engagement surfaces consist of parts of the circumferential surface of small wheels or rollers. The small wheels or rollers are capable of rotating about shafts that are perpendicular to the centre line of the shaft about which the pulley rotates, or in case of said small angle a, about correspondingly oriented shafts.

In an alternative embodiment the contact or engagement surfaces consist of surfaces of movable segments that are capable of sliding axially over the pulley.

Guidance or control means may also be present as a result of which the belt part wound around the pulley will move axially such that the axial displacement per revolution corresponds to at least the belt width. This means that the belt part wound around the pulley in case of a rotating pulley at sight no longer moves sideward because the winding added at every revolution is slid to the place of the previous winding during that revolution. The axial shifting of the belt over the pulleys can now take place involving little energy and wear as a result of which the belt drive according to the invention is highly suitable for continuous drives, also with larger powers, and also offers the possibility to realize variable transmissions having high efficiency, that are relatively small-sized and at relatively low cost.

In the drive use can be made of belts and bands that can be made based on the existing technique for manufacturing high-grade V-belts and toothed belts having large strength and a long lifespan. As the power transmission between the tension cords in the belt and the pulley does not take place via synthetic teeth or via a relatively thick rubber layer but more directly via a rather thin tread surface that deforms very little, larger forces and powers can in principle be transmitted per belt with the same belt sizes (width and/or height).

Simple embodiments of belts can therefore be used, such as for instance a non-toothed belt, for instance having a rectangular cross-section.

The invention furthermore provides a vehicle provided with a drive according to the invention.

The invention furthermore provides an endless belt for transmitting power from a driving shaft to a driven shaft. The endless belt has a tensile reinforcement, such as tension cords or the like, wherein the portion of the belt that, considered in cross-section, is situated at the radial inside of the belt has a radial size that at the most equals the radial size of the portion of the belt that is situated at the other side of the tensile reinforcement. The belt may have a constant cross-section.

The invention furthermore provides a pulley for a drive provided with a drive belt, which pulley is disposed on a driving shaft or a driven shaft, wherein the pulley is provided with support surfaces for the drive belt, wherein the support surfaces are adjustable in radial distance to the centre line of the pulley. In one embodiment the support surfaces are supported via first supports on support surfaces of second supports in the rest of the pulley, wherein the location of the effective support surfaces of the second supports is radially adjustable. This may for instance be done with an adjustment part circulating with the pulley, which adjustment part can temporarily be given a speed deviating from the pulley speed in order to adjust the radial position of the support surfaces.

The contact or engagement surfaces may be provided with a convex surface in a cross-section according to a radial plane of the belt. The convex surfaces are then formed and placed such that the belt is able to abut over at least the entire surface of said surfaces. To that end the tangents, considered in a radial plane of the pulley, of engagement surfaces that are adjacent in pulley circumferential direction, at the location of their edges that face each other, may be situated on or beyond the chord connecting said edges to each other. In other words they are formed such that a circumferential line following the convex surfaces and comprising the said chords has no recesses that extend radially inward. The said surfaces therefore define the minimum bending radius of the belt over the pulley. Said bending radius will in general be smaller than the average radius of the belt on the pulley, but indeed approximate it, depending on the surface occupation degree of the said surfaces over the circumference.

In one embodiment having an adjustable position of the engagement surfaces in radial direction the convexity of said surfaces in the radial plane may correspond with approximately half the minimum radius that can be set of the entire engagement surface for the belt on the pulley. Further embodiments are described in the attached claims, the text of which should be deemed inserted herein.

The aspects and measures described and/or shown-in the application may where possible also be used individually. Said individual aspects, such as pulley, belt and other aspects may be the subject of divisional patent applications related thereto.

Is it noted that from U.S. Pat. No. 6,280,358 a movement mechanism is known for reciprocally moving a gate, wherein the gate is movable by means of a carriage. A belt is wrapped around two driving pulleys on a same shaft, wherein the belt is guided between those pulleys over a tension pulley. A block is attached on the belt for continuous or semi-continuous transmission of power to a driven shaft. British patent specification 413.450 regards a drive for a rope, wherein the rope to be driven is wrapped around a pulley over 180 degrees.

British patent specification 361.940 shows a belt drive having three pulleys, wherein the belt on each pulley between the incoming and outgoing part includes an angle in the order of 180 degrees.

### BRIEF DESCRIPTION OF THE DRAWINGS

The invention will be described and elucidated below on the basis of exemplary embodiments shown in the attached drawings, in which:

FIG. 1 shows a general embodiment having a fixed transmission ratio between the number of revolutions of the driving and of the driven shaft, as well-as views according to A-A′ and B-B′;

FIG. 2 shows a first possible embodiment of axial belt guides on a drive according to the invention;

FIG. 3 shows a second possible embodiment of axial belt guides on a drive according to the invention, in cross-sections B-B′ and A-A′, respectively;

FIG. 4 shows a third possible embodiment of axial belt guides on a drive according to the invention, in cross-sections A-A′, B-B′ and C-C′, respectively;

FIGS. 5A-C show a number of possible embodiments of axial belt guides having sliding segments on a drive according the invention, in cross-sections A-A′ and B-B′, respectively;

FIG. 6 shows a fourth possible embodiment of axial belt guides on a drive according to the invention, in cross-sections A-A′ and B-B, respectively, as well as two details;

FIG. 7 shows a fifth and sixth possible embodiment of axial belt guides on a drive according to the invention, in cross-sections A-A′ and B-B, respectively, and in cross-sections A-A′, B-B and C-C′, respectively;

FIGS. 8-10 show a schematic view of some examples of belt drives according to the invention;

FIGS. 11 and 12 show more detailed embodiments of the construction of the pulleys for the drives of FIGS. 8-10;

FIG. 12A shows a schematic example of an alternative arrangement with control rings; and

FIG. 13 shows the course of powers in an axial guide that has been rotated over a small angle to the centre line of the shaft of the pulley.

### DETAILED DESCRIPTION OF THE DRAWINGS

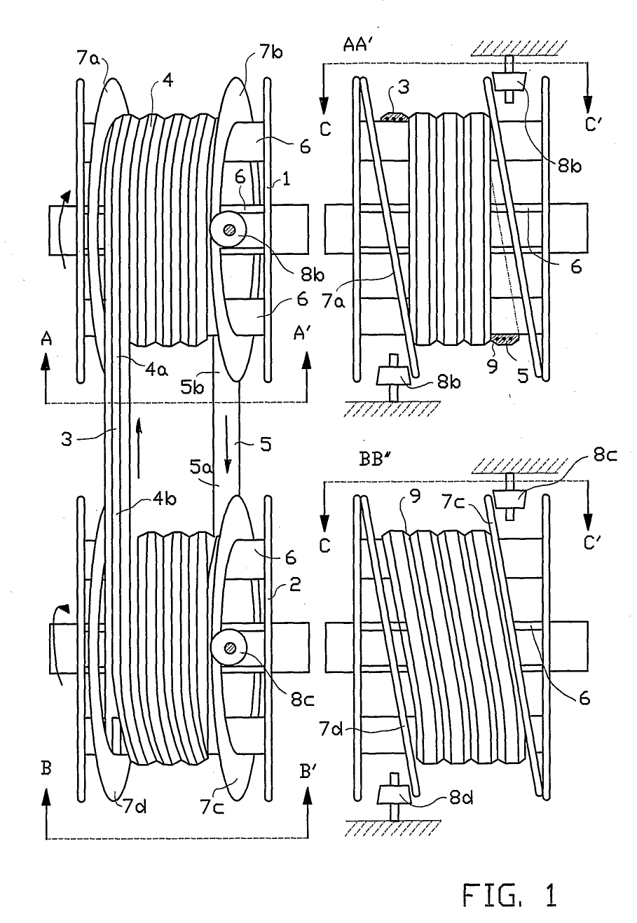

In FIG. 1 an embodiment is shown having two pulleys of which 1 is the driving and 2 the driven pulley. The part 3 of the belt 4 is the pulling part and the part 5 is the low-tension part. In the direction of rotation indicated the part 4a is the incoming part of the pulling part and the part 4b is the outgoing part. Furthermore part 5a is the incoming part of the low-tension part and 5b is the outgoing part of the low-tension part 5. Per pulley there are four axial guides 6. This number will in actual use be larger in order to reduce the polygon effect which effect can be further reduced by among others giving the distances between the axial guides along the circumference of the pulley a different length.

The tread surface of the belt is free from local discontinuities (other than optional teeth) and may as a result circulate continuously.

The belt may axially move with little friction over said axial guides 6 but in tangential direction it is exposed to large frictional force. For the sake of clarity the structure of the axial guides themselves is not shown in this figure, but will be elucidated further below. The belt is wound 3.5 times about the pulleys resulting in this case in a contact angle of approximately 3.5×360 degrees=1260 degrees. As a result the maximum ratio between the tension in the low-tension part and the pulling part in case of a tangential frictional coefficient of 0.3 in conformity with the calculation applicable thereto equals approximately 545. This means that also in case of a very low pre-tension in the low-tension part a large force can still be transmitted by the pulling part of the belt without slip occurring.

The tension in the low-tension part is kept constant using a tensioning wheel under spring tension that is not shown in the drawing.

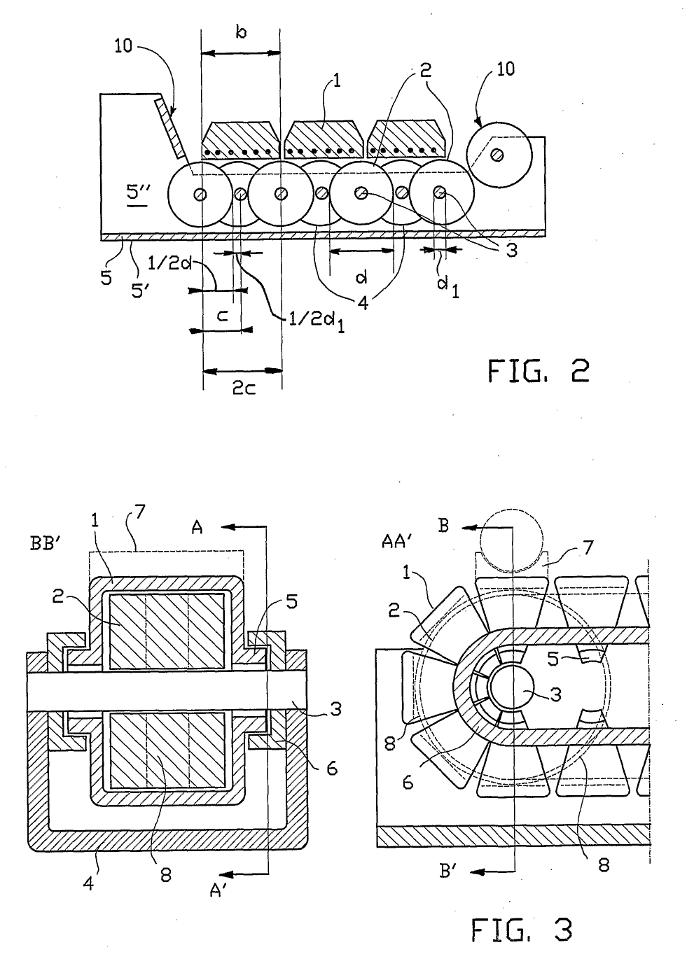

The belt is able to move axially on the pulley under the influence of belt tension and using a bevel 9 of the side of the belt and by a sideward belt guide 10 (see FIG. 2) at the sides of the axial guide. This simple guide may under certain circumstances be insufficient, particularly in case of low belt tension in the low-tension incoming part in combination with the remaining axial force necessary to move the wound belt part axially over the pulley. In order to safeguard an axial control of the axial belt movement, control disks or control rings 7a-7d have been arranged. They rotate along with the pulleys, due to friction with the belt or due to coupling with the pulley, yet at the outside may locally move axially with respect to the pulley (particularly tilt with respect to a radial plane through the axis of rotation of the pulley) and be axially supported by the stationary positioned rollers 8a-8d.

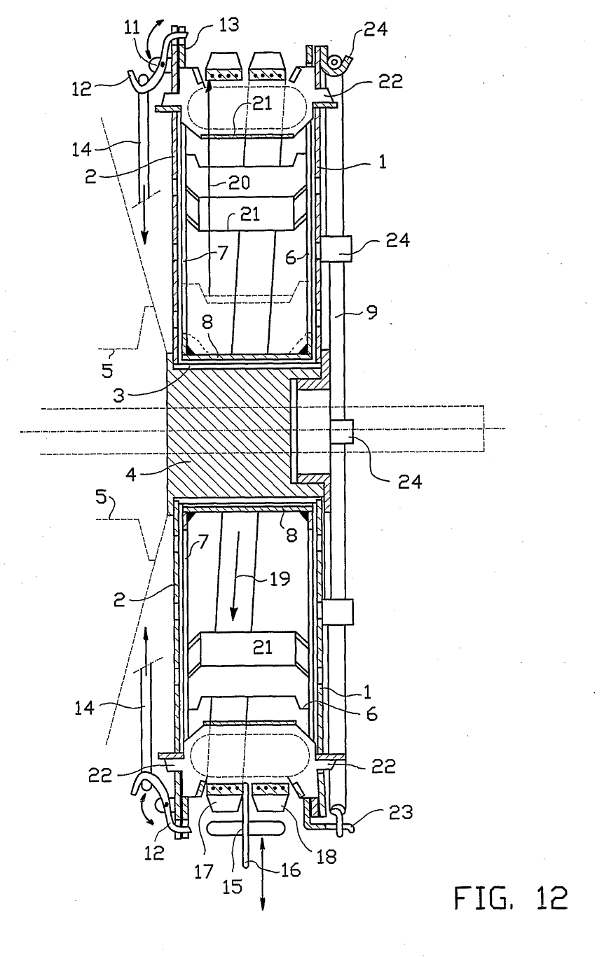

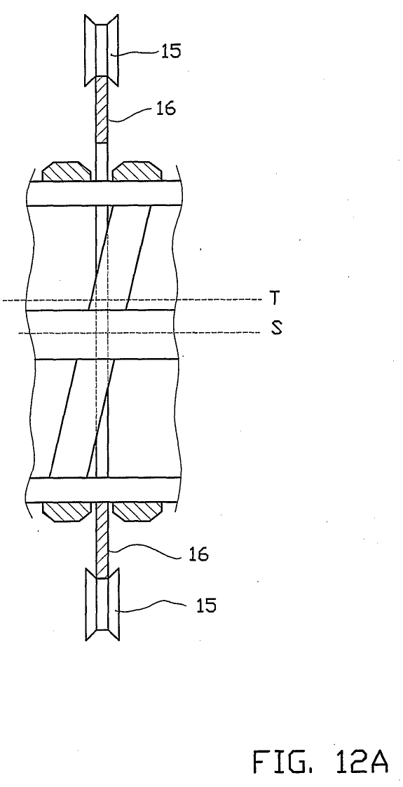

In radial direction the control disks or control rings in FIG.1 are concentrically supported by the drive shaft. However, they may also rotate eccentrically in a permanent position wherein the inner circumference of the ring comprises the outer circumference of the pulley, see for instance FIG.12A. They have to be supported by stationary positioned guides or rollers that are adapted for that purpose.

In case of adjustable pulleys the position of said guides or rollers will also have to be adjustable in that case.

In the case drawn there is one support roller per control disk, yet this number may if necessary be increased. The incoming part 4a of the pulling part of the belt is pushed to the right by control disk 7a and as a result slides axially to the right over a revolution of the pulley over a distance of at least the belt width so that the axial position of the incoming part always remains the same. The same applies for the incoming part 5a of the low-tension part 5 under the influence of control disk 7c. As the control disks shift the entire wound belt part, the outgoing parts also remain in their place. The control disks 7b and 7d are not needed for this, but become operative when reversing the direction of rotation and then operate similar to 7a and 7c.

Another way to shift the belt axially is indicated in FIG. 12. Here the belt is shifted axially using a control disk 15 that is placed eccentrically with respect to the pulley and rotates about a shaft that is parallel to the axis direction of the pulley or deviating therefrom over approximately the angle at which the belt is to the radial plane at that location, for instance the said 20 degrees at the most. Said control disk, considered axially, is always in a stationary position. In case of a pulley with a variable diameter the control disk 15 may move axially along with the belt and remain in contact therewith.

The control disk 15 is positioned at the location where the incoming part of the belt reaches the outer circumference of the pulley. This means that the belt part that reaches the pulley will not be axially shifted until after approximately one revolution. In situations wherein the incoming part 18 is also the pulling part the tensile stress in that belt part will at that moment have been considerably lowered as a result of which relatively little force is needed to axially displace the belt. However, it is also possible to position the control disk 15 more “upstream” as a result of which the axial shifting takes place sooner and in that situation at a greater force. Furthermore it is also possible to use a simple fixed guide instead of a rotating guide 15, wherein the axial forces necessary for shifting, however, will be relatively greater.

Another possibility is shown in FIG.12A. In that example use is made of a control ring 16 which is rotatably bearing mounted in a number of fixed, freely rotating rollers 15 two of which are shown. The rotation centre line T of the control ring 16 is eccentric with respect to the rotation centre line S of the pulley. The distance of the rollers 15 and the radial size of the control ring 16 are such that they can extend in a circumferential path between the adjacent belt parts (see below) and in another circumferential path remains radially spaced from the belt parts, as shown at the top, where the belt parts are able to pass under the control ring.

In FIG. 2 the embodiment of an axial guide is shown, consisting of a U-shaped carrier 5 having bottom 5′ and upright side walls 5″ (only one is shown) in which the shafts of one or more rows of wheels are arranged. Here 1 is the cross-section of the belt that is capable of rolling over a row of wheels 2 that rotate freely about shafts 3 that are perpendicular to the centre line of the shaft of the pulley and are bearing mounted therein in the sidewalls 5″. As a result the belt is able to move in axial direction with little friction whereas for the movement in tangential direction (perpendicular to the plane of the drawing), the frictional coefficient is active that applies for the material used for the outer circumference of the wheels and the material of the belt.

In order to prevent that the belt will twist it is supported by at least two wheels which means that the wheel diameter d at the most is as large as half the belt width b. This means that the wheel diameter in actual practice will become very small, whereas the forces occurring may be rather large. This renders it difficult to arrive at a constructive design of wheels and bearing having a sufficiently long lifespan and an acceptable price level.

The wheel diameter can be increased relatively when for the axial guides a second row of wheels 4 is used that is closely adjacent to the first row 2 and shifted axially over a length c with respect to the first row, wherein it can be seen in the drawing that c equals half the wheel diameter plus half the shaft diameter d1. In this case the requirement applies that c may at the most equal half b or c=1/2b=1/2d+1/2d 1 or d=b−d1.

In case of a bearing at a side d1 will equal nil and the maximum wheel diameter may then at the most be equal to the belt width b.

FIG. 3 shows an embodiment of an axial guide having sliding segments 1 that slide over a material 2 having a low frictional coefficient, for instance Teflon. This material 2 is attached with pins 3 in the middle of a U-shaped carrier 4. In order to further reduce the friction of the segments, spaces may left open in the material 2 in which wheels 8 are accommodated that rotate about the pins 3. In the drawing said wheels 8 are shown in dotted lines. The segments 1 are kept in their track because protruding parts 5 of the segments move in the round-going guide 6. It is also possible to movably connect the segments to each other into a round-going segment chain.

The segments 1 may be provided with feet 7 in which for instance a belt having a circular cross-section may be accommodated. This is indicated in the drawing with dotted lines.

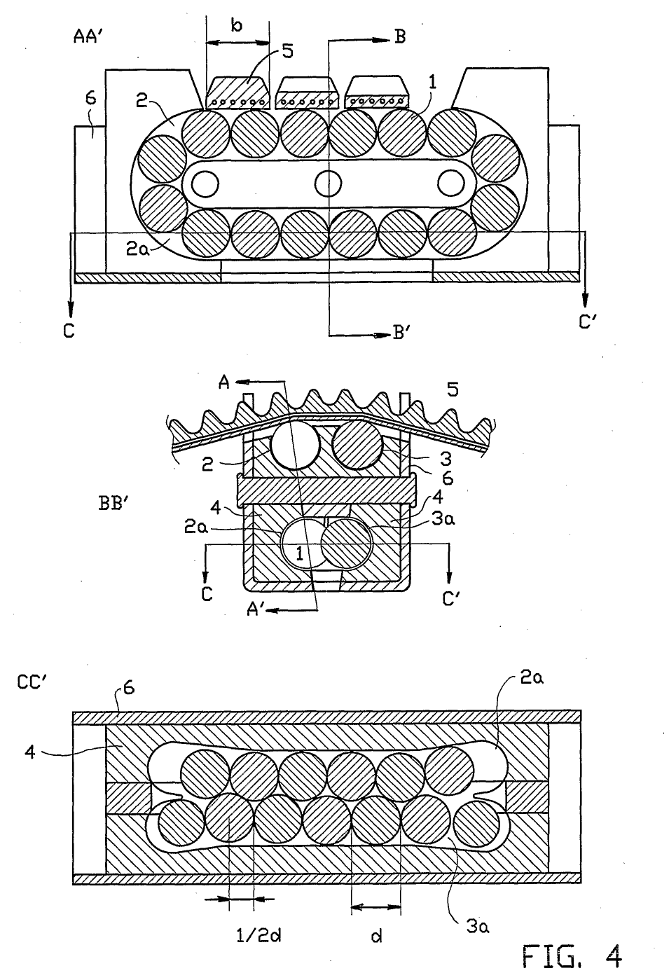

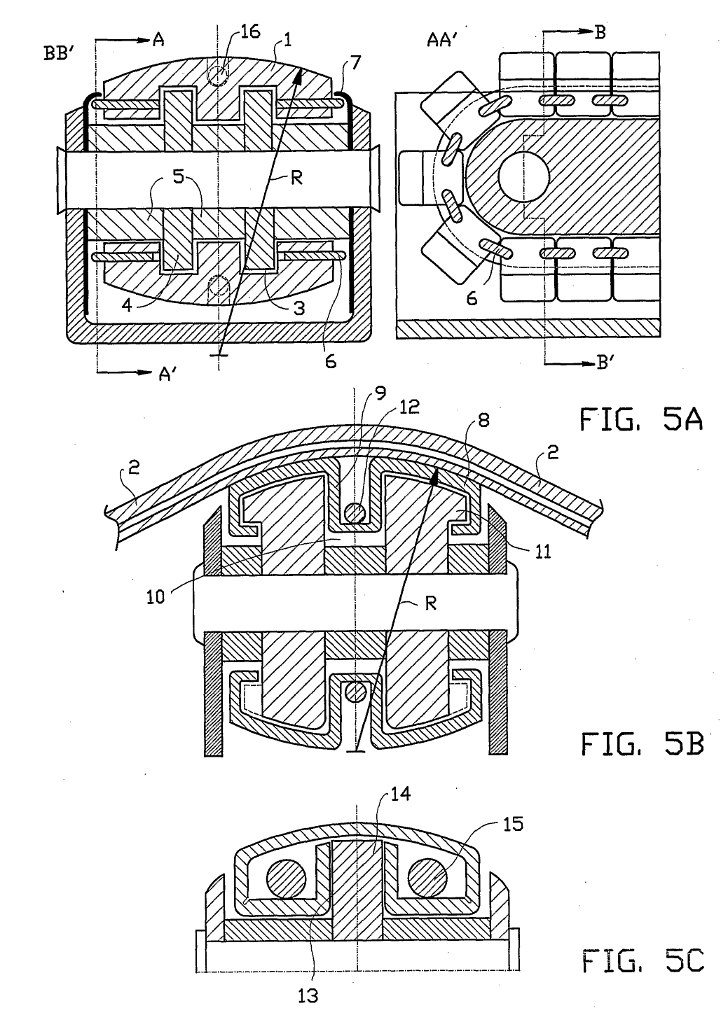

In FIG. 4 an axial guide is shown wherein instead of wheels use is made of balls 1 that roll within a ball track 2. One or several ball tracks are possible: in the drawn embodiment there are two adjacent ball tracks 2 and 3. The balls run in an endless track wherein the lower most part 2a and 3a of both ball tracks can be combined into one track of such a width that the ball rows engage laterally into each other, as a result of which the two ball rows are no longer able to shift axially with respect to each other, In this way it can be achieved that the balls in the upper parts of their track are shifted over the desired distance of half d in axial direction with respect to each other, as a result of which just like the wheels of FIG. 2 the diameter of the balls d may at the most be equal to the belt width b.

In the upper ball track the balls are subjected to a large frictional force that counteracts rotating in a radial plane (of the pulley). The ball tracks are supported by the U-shaped metal carrier 6 that forms an axial guide and here are made in a material 4 of synthetic material or metal and having a frictional coefficient to the material of the ball that preferably corresponds with the frictional coefficient between the belt 5 and the balls.

When the latter coefficient is higher the balls will start to rotate near the tensile stress in the belt at which slip will occur between the surface of the balls and the material 4. In case a synthetic material is used for 4 it is possible to incorporate metal parts around the portion of the ball tracks that contact the belt, where the balls are highly loaded by the belt tension.

In FIG. 5a the segments 1 are provided with a radius R that has such a value that R is the minimum radius over which the belt 2 (FIG. 5a) is bent. In case of an adjustable pulley said radius will be rather small with respect to the radius related to the maximum diameter of the pulley, yet in non-adjustable pulleys said radius may be large and differ little from the maximum radius of the pulley.

The segments are axially guided through a slit 3 in the segment corresponding to a raised edge 4 of the support 5. Several slits and edges are possible. The segments are hinged to each other via a U shaped connection piece 6 that is also used to keep the segments in their track using the guide edge 7 which in this case is only present at the upper side, yet which may also fully run around the segments.

In general the segments are made of metal having a high frictional modulus with respect to the material of the belt. The materials of the support have a low frictional modulus with respect to the material of the segments.

In FIG. 5b the segments are made of bent plate material 8. The axial guiding takes place by means of the recessed section 9 and the slit 10 in the support, whereas the guide edge 11 in this case is disposed at the inside. The segments are kept in their circulating track here by means of a fixed or flexible and elastic band 12.

Also in FIG. 5c the segments consist of bent plate material. In this case use is made of a groove 13 and a raised edge 14 just like in FIG. 5a. The segments are held together by one or more 0-rings 15 that are accommodated in the inside of the segments.

Combinations of the embodiments described here are possible. For instance the segments of FIGS. 5b and c may also be connected to each other and said connection and/or guide edge in FIG. 5a can be dispensed with when disposing a groove with O-ring 16. The simplified embodiments can be used in case of lowered requirements for instance in case of short axial guides, low numbers of revolutions and low powers. In this case use can also be made of adapted embodiments of metal wristwatch chains, of which the links in transverse direction have a convex surface and are movably, optionally elastically, connected to each other. The “watchband” may in that case circulate around a stationary body. In case of larger pulleys, rolling segments can be used as a result of which in fact combinations are created of the axial guides described in this patent specification. The description of the convex shape discussed above can be used in all arrangements of axial guides discussed.

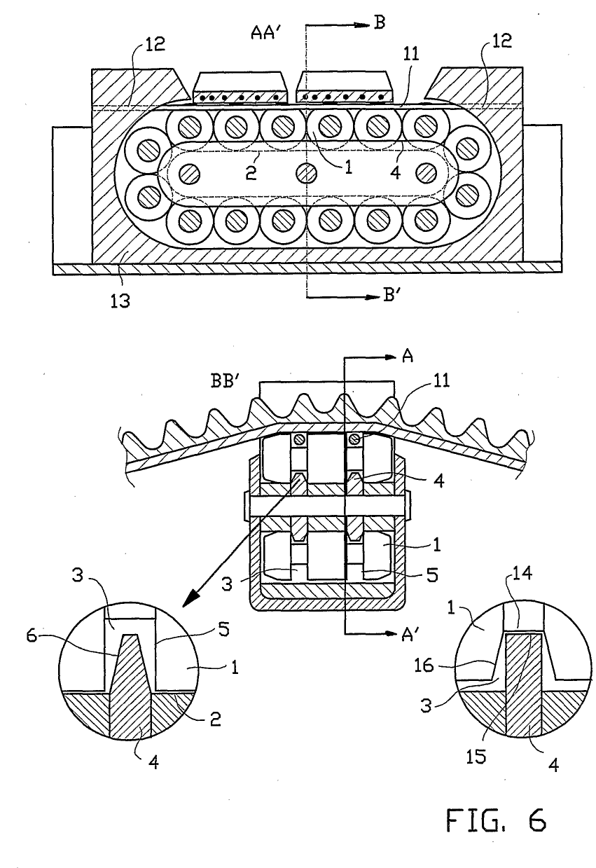

FIG. 6 shows an axial guide having rollers 1 that roll over an endless track 2. Movement in tangential direction is prevented because the rollers are provided with grooves 3 that correspond with a raised edge 4 that protrudes from the track 2. By giving the grooves a rectangular profile 5, and providing the edge with a bevel 6, it is achieved that the occurring roll resistance as a result of the tangential forces occurring is minimal.

Said tangential guide grooves 3 in the rollers may also serve to accommodate one or more flexible or elastic or rigid guide bands or wires 11 that keep the rollers in their track. In FIG. 6 this only happens at the upper side where two straight wires 11 of for instance spring steel are attached to the sides of the axial guides at 12.

Said guidance by wires or otherwise may also be fully round-going through the grooves 3 along the outer circumference of the rollers and in that way keep the rollers in their place. The outer guide 13 may then be dispensed with.

Furthermore this round-going outer guide may be provided at the inside of semicircular recesses that fit around the reduced diameter of the rollers within the groove. As a result the rollers are kept spaced apart and rotate in the semicircular recesses wherein the outer guide here functions similar to the cage of a ball bearing.

For accommodating these round-going outer guides separate grooves may naturally also be made in the rollers.

In FIG. 6 the rollers with their outer circumference are in contact with the round-going track 2. It is also possible to let the rollers with the inside 14 of the groove 3 roll off over the outer edge 15 of the raised edge 4. The bevel 16 then has to be disposed at the sides of the groove 3. In the drawing this is shown enlarged in detail on the right-hand side of FIG. 6BB′, whereas on the left-hand side the situation described earlier on is shown enlarged.

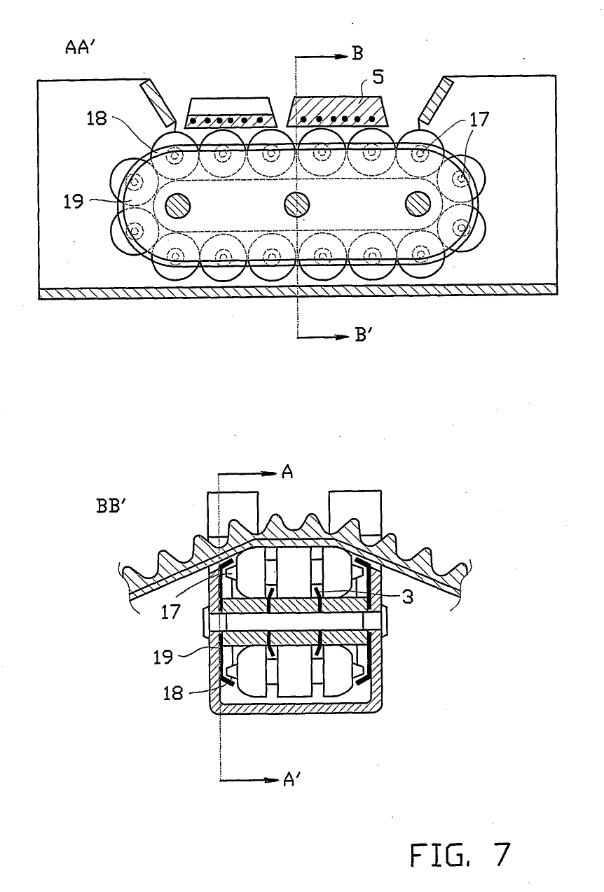

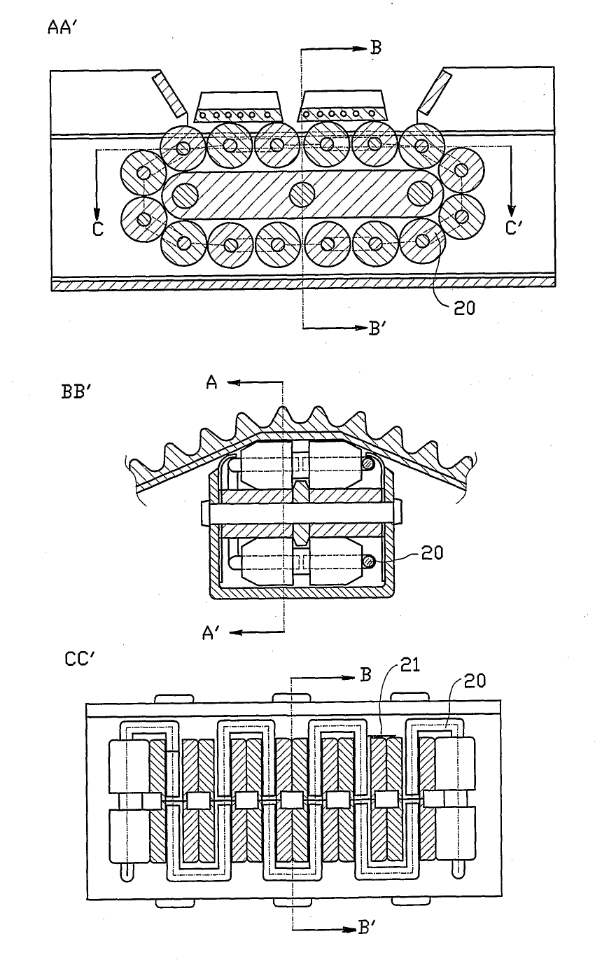

In FIG. 7 an embodiment is shown wherein the rollers are provided with a shaft stub 17 on both sides. This shaft stub 17 is guided past the round-going inside of the turned edge 18 of a plate 19. In this way the rollers are kept in their place.

The shaft stub 17 here forms a unity with the roller but may also be created by providing the rollers with a bore hole in which the shafts are placed. In the second depicted embodiment in FIG. 7 said shafts are designed like U-shaped bent shafts 20 that each time connect two rollers. By in this way each time connecting two shafts to each other it is also prevented that the rollers come to be inclined wherein the centre lines of the rollers are no longer at right angles to the direction of movement of the belt over the axial guides.

The connection of the rollers can be further improved by adding extra connection plates, each provided with two holes with which the U shaped bent shafts are connected. For clarification, such a plate 21 is drawn in the bottom picture cc′.

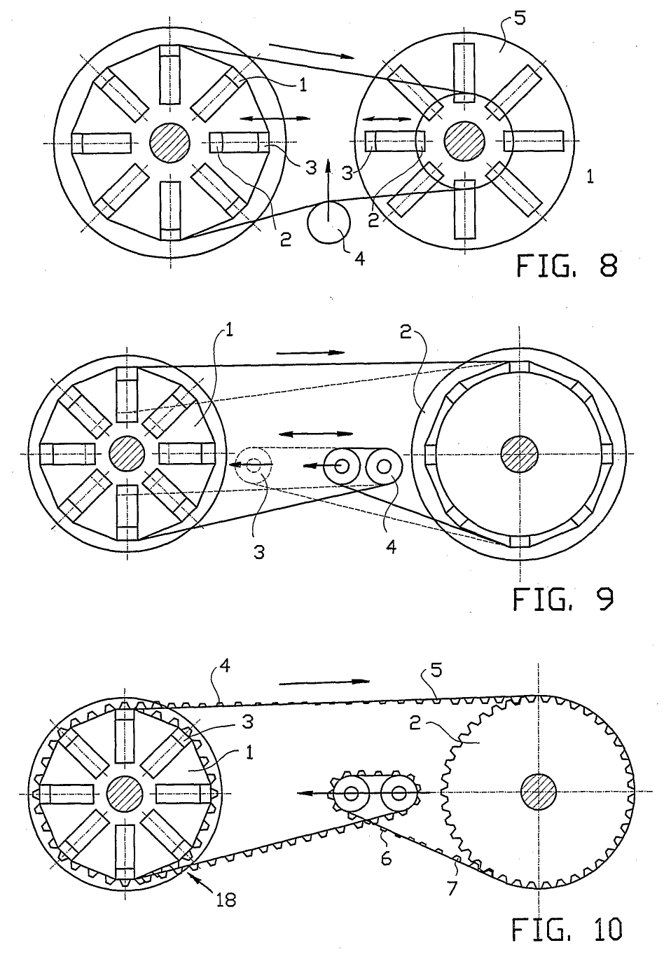

FIG. 8 shows a schematic embodiment of the drive having two pulleys with variable diameter, wherein the axial guides 1 are radially movable from a position with a minimal diameter 2 to a position with maximum diameter 3. Pulley 5 in this case is the driving pulley. The belt length taken in the diameter increase of the one pulley here equals the released belt length created when reducing the other pulley. The low-tension part is kept at tension using a spring-mounted auxiliary pulley 4 in the known manner.

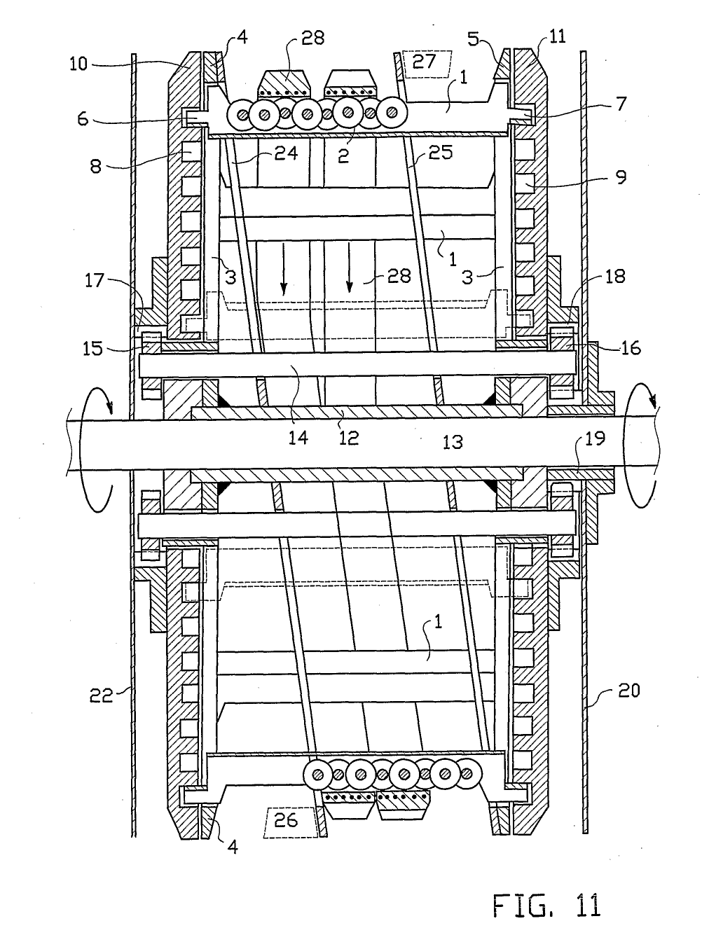

FIG. 9 shows a schematic embodiment of a drive having a driven pulley 1 with variable diameter and a driving pulley 2 with a fixed diameter. In order to in this case take the belt length released at reduction of the pulley 1, two auxiliary pulleys 3 and 4 are necessary wherein auxiliary pulley 3 is movable in order to in that manner take a belt length or to release it and keeping the low-tension part under pretension.

FIG. 10 is a variant of the embodiment of FIG. 9 wherein the driving pulley 2 of FIG. 9 is replaced by a toothed pulley 2 with a fixed diameter. In this case a side of the belt it provided with teeth that fit in the teeth of the fixed pulley 2 whereas the other side of the belt is in contact with the axial guides 3 of the adjustable pulley 1. The belt parts 4 and 5 and also the belt parts 6 and 7 in that case are twisted over an angle of 180 degrees. Compared with the embodiment of FIG. 9 the pulley 2 of FIG. 9 is replaced here by a narrower toothed pulley.

Of course more driving configuration than the ones in FIGS. 8-10 are possible. An interesting driving configuration is among others the one in which on the driving shaft a pulley is attached on which two belts run adjacently. The first belt drives a pulley that is attached to the driven shaft in the manner shown in FIGS. 8-10, and the driven shaft as a result for instance rotates clockwise. The second belt is also wound around a pulley of the driven shaft but compared to the first belt the direction of winding is the other way around, which means that the driven shaft by the second belt wants to rotate anticlockwise. In case of a constantly rotating driving shaft the driven shaft will rotate clockwise when the low-tension part of the first belt is tensioned and anticlockwise when the low-tension part of the second belt is tensioned. Said embodiment therefore operates like a reverse coupling or gear and offers an option for driving the propeller shaft of a ship as an alternative for a so-called V-drive.

In a similar way several belt drives with different fixed transmission ratios can be arranged parallel between two shafts wherein the desired transmission can be selected by tensioning the low-tension part in question.

FIG. 11 in more detail shows a possible constructive embodiment of an adjustable pulley for particularly the configuration of FIG. 8 and for larger capacities, such as for instance used for driving motor vehicles. The belt is supported in the axial guides 1 by wheels 2, but support by sliding segments, rollers or balls is also possible.

The control disks 24 and 25 function in a way indicated in FIG. 1. The stationary positioned support rollers 26 and 27 are indicated in dotted lines. The shaft 13 is the driving shaft having the direction of rotation indicated by the arrow. The incoming part of the belt 28 reaches the pulley at the top left of the drawing and moves downward with the pulley rotating, in accordance with the arrow direction, until the control disk 24 is contacted. Then the control disk pushes the belt to the right until the lowermost position is reached. Subsequently the belt moves straight up and again further down until the position is reached wherein both windings are pushed to the right by the control disk. Finally the belt reaches the lowermost final position after which the belt leaves the pulley. Control disk 25 is present for the reversed direction of rotation. The axial control can also take place in another way.

The axial guides 1 are radially led into radial slits 3 of the left-hand radial disk 4 and the right-hand radial disk 5. The axial guides are provided with a left-hand and a right-hand guide cam 6 and 7 that fit in spiral slits 8 and 9 of left-hand and right-hand spiral disk 10 and 11, that function as adjustment part for the radial position of the axial guides. The axial guides can now be moved to another diameter by simultaneously rotating the radial disks 4 and 5 with respect to the spiral disks 10 and 11. The spiral disks in this case each preferably have a spiral-shaped groove with a small pitch as a result of which the radial support of the axial guides is self-decelerating. In order to safeguard that the radial disks move simultaneously they are fixedly connected to the tube 12 and the continuous shaft 13, whereas the spiral disks rotate with each other by the coupling rod 14 which via toothed wheels 15 and 16 is coupled to the internal crown gears 17 and 18, that are attached to the spiral disks 10 and 11.

The toothed wheel 16 of the coupling rod 14 is also in engagement with the toothed wheel 19 that is bearing mounted on the shaft 13 and attached to a thin regulating disk 20 having a large diameter, which at the outside can be decelerated by a brake device that is not depicted. A same regulating disk 22 is attached to the left-hand spiral disk 10 and can be decelerated with a brake device that is not depicted. The brake devices may be designed in any suitable way, for instance in the form of a disk brake.

When shaft 13 is the driving shaft rotating constantly according to arrow direction, the diameter of the pulley can be reduced by decelerating the disk brake or the regulating disk 22. When the direction of rotation of the driving shaft is reversed the diameter will be enlarged when decelerating 22.

In order to increase the diameter, while maintaining the direction of rotation, the regulating disk 20 will have to be decelerated. The deceleration of the regulating disk 20 after all means that the toothed wheel19 will rotate more slowly than the shaft 13. Crown gear 18 driven by toothed wheel 16, however, will as a result start rotating faster than shaft 13 and so will the spiral disk 11 attached to this crown gear 18. The coupled spiral disks 10 and 11 thus rotate such that the diameter of the pulley increases. In this way the diameter of this pulley can be regulated with the electrically or mechanically or hydraulically operating brake devices.

Due to this diameter adjustment an electronic setting of the transmission ratio can be realized wherein first, in case of a rotating driving shaft, a minimum diameter reduction of one of the pulleys is initiated by deceleration (by operating the accompanying brake) of the disk brake in question. As a result a reduction of the tension in the low-tension part arises because the belt becomes slightly too long. This tension is measured (for instance by measuring the motion of the tension roller) and passed on to the control (central control unit) with which the brakes can also be operated. The control corrects the effect by via the disk brakes increasing the diameter of the other pulley. In this way the transmission ratio can also be adjusted under load. This cycle is subsequently repeated until the desired transmission ratio is achieved.

In case of a rotating driving shaft the diameter of the driving pulley can be reduced by using the disk brakes. In order to achieve that the driven pulley in case of a standstill also accommodates the belt length released due to expansion it is necessary that this pulley for instance under spring tension (also see the discussion of FIG. 12 below) expands to a larger diameter as soon as the belt tension drops below a certain value.

In case of stationary pulleys a small auxiliary motor is necessary for varying the belt diameters, which motor rotates the spiral disks with respect to the radial disks.

In order to increase the belt diameter the belt tension first has to be reduced by electrically or mechanically reducing the force on the tension roller.

In FIG. 11 only one belt is present. It is possible, however, to place several belt adjacent to each other and as a result transmit a larger capacity and torque with the drive.

In FIG. 11 use is made of two spiral disks and two radial disks wherein the axial guides supported and guided at two sides. It is also possible to use with one radial disk for the bearing of the axial guides with additionally one or more spiral disks for moving said axial guides. In case of more than one spiral disk each spiral disk is able to operate a part of the present axial guides, as a result of which a larger angular displacement of the spiral disks is available for the maximum adjustment.

The radial displacement of the axial guides is also possible using spindles and nuts, wherein each axial guide is radially movable via a guide in the pulley and is moved by a radially placed spindle that is movable in that direction by rotation of in the accompanying nut, wherein the corresponding and radially supported nut is rotated using a small toothed wheel co-rotating with the nut, wherein the ring in question of small toothed wheels via transmission at right angles is in engagement with a central toothed wheel that forms an adjustment part and due to friction co-rotates about the centre line of the pulley. When said central toothed wheel is rotated with respect to the pulley the small toothed wheels and thus the nuts will rotate as a result of which the spindles with the axial guides will simultaneously move radially.

The rotating of the central toothed wheel with respect to the pulley has the same function and effect as the rotation of the spiral disks with respect to the radial disks described above and therefore can be read in its stead.

It is observed that in the said slanted position of the axial guides (angle a) which will also be described below, the possible alteration of said angle in the adjustment in radial direction can be taken into account in the design.

In FIG. 12 an adjustable pulley is shown that might be used for driving a bicycle in conformity with the configuration of for instance FIGS. 9 and 10.

The embodiment of the pulley is, as regards the use of spiral and radial disks, comparable to the one of FIG. 11, the difference being that in this case the spiral disks are attached to the driven rear wheel. This is necessary also because in case the driven wheel is at a standstill, the radial disks must be capable of being rotated by the belt.

Several spiral-shaped grooves have also been disposed in the spiral disks in connection with the relatively large pitch. The pitch is large here because already in case of small angular displacements a considerable change of diameter is wanted. In principle each axial guide 21 here has an own groove wherein the cams 22 move.

The axial guides 21 can move radially according to the arrow 20, and are here provided with rollers or axially sliding segments, for instance as described above.

In this case the two spiral disks 1 and 2 are slid around the outside 3 of the free wheel housing 4 of a rear hub 5 of the bicycle. The outside is provided with axial ribs or ridges that fit in the groove of the spiral disks. Thus the spiral disks are locked against rotation with respect to the free wheel housing 4. The two radial disks 6 and 7 are attached to each other via tube member 8 that is able to rotate about the freewheel housing 4 and which, due to the long tension spring 9 along the circumference of the spiral disk 1, is rotated with respect to the spiral disks in a direction wherein the axial guides move towards the largest diameter of the pulley.

The spring 9 is supported along the circumference of the spiral disk 1 by the supports 24 and at one side is connected to the radial disks via part 23 whereas the other side is connected to the circumference of the spiral disk 1.

In order to prevent undesirable rotation of the spiral and radial disks with respect to each other, these disks are coupled by means of a ratchet mechanism11, wherein a rotatable ratchet 12 attached to the outside of the disk 2 is in engagement with a corresponding crown gear 13 of the radial disk 7. By lifting the ratchet so that it is no longer in engagement the disks 2 and 7 are uncoupled.

Said uncoupling can be remotely operated counter a spring pressure using a round-going cable 14. By tensioning the cable 14 the ratchets along the circumference are lifted and the disks uncoupled, wherein the spiral disks in the depicted case are decelerated by the cable against rotation.

The depicted cross-section of the pulley at the rear wheel is considered in the direction of the crankshaft of the bicycle. The belt part 18 is the low-tension incoming part. This part subsequently runs straight upwards and then according to the arrow direction 19 diagonally downwards.

In order to direct the belt axially to the left, in this case the control wheel 15 is present, which is provided with a flange 16 that exerts a force to the left on the side of the part 17 of the belt sitting on the pulley, as a result of which this part of the belt cannot be wound up to the right and there is always room on the pulley for the incoming part 18. The control wheel 15 follows the radial movement of the axial guides 21 for instance by means of a spring that is not further shown that keeps the control wheel 15 pressed radially against the outside of the belt. The control wheel is axially kept in the same position at all times. The axial control can also take place by means of simple guides that do not co-rotate, but the frictional losses occurring will be larger then.

The changing of the transmission ratio by the cyclist now takes place as follows.

First the cyclist uncouples the spiral and radial disks via the cable 14 and the spiral disks are decelerated by the cable. By now pedaling forward the axial guides move to a smaller diameter as the spiral and radial disks rotate with respect to each other. As a result the transmission ratio is increased. By pedaling rearward the reverse occurs and also due to the activity of spring 9 the axial guides will move to a larger diameter. Said motion is opposed by the pre-tension in the low-tension part 18 of the belt, but said pre-tension is very low in case of the belt drive. However, it may be necessary to remove said pre-tension using appropriate means or clamping the belt part 18 (see FIG. 10) during adjusting the transmission ratio. By letting go of cable 14 the radial and axial disks are coupled again by the spring-loaded ratchet 12 and thus the transmission ratio is fixed.

The embodiment of the driven pulley according to FIG. 12 may also be used for an alternative bicycle drive in conformity with the configuration of FIG. 8 using two variable pulleys. Said transmission can achieve a large transmission ratio with relatively small dimensions and also seems suitable as simple variable transmission for lightweight vehicles and for industrial applications. The transmission ratio for the sake of simplicity is preferably changed in unloaded condition by increasing or reducing the diameter of the driving pulley 5 in FIG.8 and simultaneously reducing or increasing the diameter of the driven pulley.

Changing the transmission ratio of the drive can be described as follows.

The driving pulley is made such here that the radial motion of the axial guides is self-decelerating wherein the radial disks are connected to the driving shaft.

The axial guides can be moved by forward or rearward rotation of the crankshaft and decelerating the spiral disks. In the industrial embodiment this may take place as described for FIG.11. In case of the application for a bicycle the axial guides can preferably be moved with radially positioned spindles that are rotated by a central toothed wheel, as described above. By decelerating said central toothed wheel and rotating the crankshaft forward or rearward the axial guides move to larger or a smaller diameter.

To change the transmission ratio first the driven pulley is uncoupled in the manner indicated above for FIG. 12 and the press-on force of the tension roller is removed. In case of the bicycle said two actions are combined with decelerating the spiral disks or the central toothed wheel of the crankshaft via tensioning an operating cable.

Subsequently the axial guides of the driving pulley are moved to a larger or smaller diameter by means of the crankshaft. When moving the axial guides of the driving pulley to a smaller diameter, belt length is released which however will be accommodated by the radial expansion of the driven pulley under the influence of the expansion spring 9 present (see FIG. 12). In case of the bicycle embodiment this expansion will be enhanced by the rearward rotating radial disks of the driven pulley.

When moving the axial guides of the driving pulley to a larger diameter, the diameter of the driven pulley has to be reduced. This reduction takes place counter the action of the expansion spring 9 and is mainly effected because the (uncoupled) radial disks of the driven shaft are rotated forward by the belt (that is under tension) and thus rotated with respect to the (decelerated) spiral disks of the driven shaft.

For the same angular displacement the diameter change of the driven pulley is larger than of the driving pulley.

When the desired transmission ratio is achieved the radial and the spiral disks of the driven pulley are coupled again, the press-on force of the tension roller is reinstated and deceleration of the spiral disk or the central toothed wheel on the crankshaft is ended by releasing the operating cable.

Another embodiment for the bicycle is the one wherein the pulley on the crankshaft is adjustable and the driven pulley cannot be adjusted.

The adjustable pulley is made such that the axial guides under spring force/spring tension move to the largest diameter yet under the torque exerted by the cyclist on the crankshaft they tend to move to the smallest diameter.

Said embodiment functions like an automatic acceleration because in case of larger pedaling force the driving pulley is automatically urged to a higher transmission ratio and in case of reduced pedaling force changes to a lower transmission ratio. The transmission ratio can be fixed in a similar manner as described above for instance by means of a cable-operated ratchet mechanism.

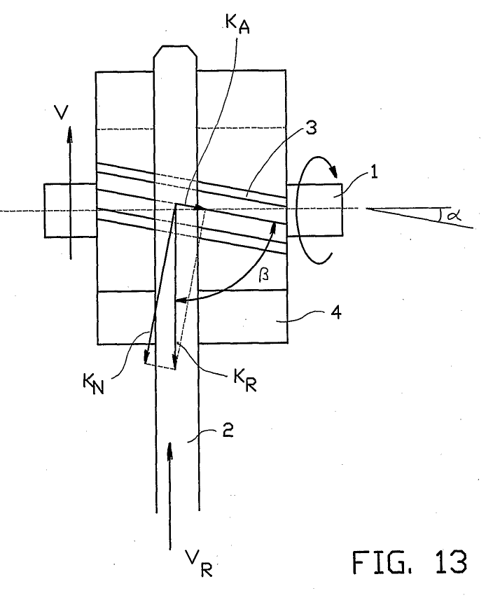

FIG. 13 shows a sketch of the distribution of forces occurring when the axial guides are not exactly parallel to the centre line of the pulley but considered in the accompanying tangential plane (as shown) are at a small angle a to a line that is parallel to the pulley centre line. In the figure the angle is slightly smaller than 90 degrees (90-a). In this example the axial guides are straight. The axial guide shown is, considered in a plane of projection containing the pulley centre line and extending perpendicular to plane of the drawing, parallel to the pulley centre line. The other axial guides are oriented in a similar way.

It is assumed here that the wheels or rollers of the axial guides rotate about shafts that are perpendicular to the longitudinal direction of the axial guides. It is also possible to place the axial guides in longitudinal direction parallel to the centre line of the pulley but to place the axes of rotation of the wheels or rollers of the axial guides slanted in the axial guides.

In the FIG. 1 is the driving shaft and Vr is the speed direction of the belt 2. Frictional force Kr is transmitted from the belt 2 to the axial guide.

This force can be resolved into a force Kn perpendicular to the axial guides 3 and a force Ka parallel to the longitudinal direction of the axial guide. As a result of said axial force Ka the belt will tend to move to the right. As a result of this axial force Ka the belt will be displaced in axial direction as soon as the force Ka becomes larger than the axial frictional force the belt is subjected to during displacement along the axial guide. By placing the axial guides slanted at a small angle (90-a) in this way, it is achieved that the belt can be more easily axially displaced by the axial control disks or that the control disks in certain case are no-longer necessary as the belt is spontaneously axially displaced under the influence of the belt tension.

Naturally it is also possible to design or place the axial guides such that the diameter of the pulley increases to one or two sides in order to thus achieve that the belt is displaced more easily or spontaneously.

1-50. (canceled)

51. Drive wherein mechanically intermittent or continuous power is transmitted from a driving shaft to a driven shaft by means of an endless belt and at least one pulley, wherein mechanic power is transmitted between belt and pulley by means of friction, wherein on said pulley the incoming part and the outgoing part of the belt are axially spaced apart wherein on the said pulley the belt has a contact angle larger than 360 degrees of angle.

52. Drive according to claim 51, provided with means due to which the frictional coefficient between belt and the said pulley is larger in tangential direction than in axial direction.

53. Drive according to claim 51, wherein the said pulley is provided with one or more contact or engagement surfaces for the belt that are movable in a direction comprising an axial directional component of the pulley, wherein the engagement surfaces of the pulley are positioned according to a cylindrical body of revolution that may or may not be interrupted in circumferential direction.

54. Drive according to claim 52, wherein the contact or engagement surfaces are movable in axial direction of the pulley or are movable according to a direction that is at a small angle a to the pulley shaft, preferably approximately 20 degrees at a maximum and the incoming part of the belt is at an angle of (90-α) degrees to the movement direction of the contact or engagement surfaces.

55. Drive according to claim 52, wherein—considered in a plane of longitudinal-section of the pulley—the engagement surfaces of the pulley are positioned according to a path that is at an angle, preferably a constant acute angle, to the shaft.

56. Drive according to claim 51, wherein the said pulley is attached to at least one of the driving shaft and the driven shaft

57. Drive according to claim 52, wherein the contact or engagement surfaces consist of parts of the circumferential surface of small wheels, balls or rollers, wherein the pulley rotates about a pulley axis, wherein the small wheels, balls or rollers are capable of rotating about axes of rotation that are perpendicular to the centre line of the pulley shaft.

58. Drive according to claim 52, wherein the contact or engagement surfaces consist of surfaces of movable segments that are able of moving, particularly sliding, axially over the pulley.

59. Drive according to claim 58, wherein the segments are movably connected to each other and move according to an endless path.

60. Drive according to claim 52, wherein the contact or engagement surfaces are convex in a radial plane of cross-section of the pulley.

61. Drive according to claim 51, wherein guidance or control means are present with which the belt can be moved in axial direction over the pulley over a distance of at least the belt width per revolution of the pulley.

62. Drive according to claim 61, wherein the belt is moved axially by a control disk or control ring rotating along with the pulley, which in an embodiment at the outside is capable of moving, particularly tilting, axially with respect to the pulley.

63. Drive according to claim 61, wherein the belt is moved axially by a fixedly positioned control member, extending from the radial outside between adjacent belt parts, for instance in the form of a control disk which does not move axially with respect to the pulley and of which the axis of rotation is situated beyond the axial guides.

64. Drive according to claim 52, wherein the surface parts over which the belt contacts form a part of axial guides distributed over the circumference of the pulley and which are radially movable with respect to the pulley.

65. Drive according to claim 64, wherein the axial guides move in radial slits or grooves of one or two radial disks and also move in spiral-shaped slits or grooves of one or two spiral disks.

66. Drive according to claim 64, wherein the axial guides are disposed on spindles that are radially oriented and are radially moved due to rotation of a central toothed wheel with respect to the pulley, wherein said central toothed wheel rotates the spindles placed radially in the pulley in order to radially move the axial guides.

67. Drive according to claim 66, wherein the pulleys with the spindles are connected to the driven or the driving shaft of the pulley, wherein the axial guides are moved by decelerating the central toothed wheel while the shaft of the pulley is rotating.

68. Drive according to claim 66, wherein the central toothed wheel and the pulley with the spindles rotate such with respect to each other under spring force that the axial guides move in the direction of the largest diameter or the smallest diameter.

69. Drive according to claim 66, wherein the central toothed wheel and the pulley with the spindles can be mechanically coupled to each other with a controllable coupling.

70. Drive according to claim 64, provided with means for altering the pre-tension of the belt during adjusting the transmission ratio.

71. Drive according to claim 51, wherein the belt is provided with bevelled edges situated at the radial outside of the belt.

72. Pulley for a drive provided with a drive belt, which pulley is disposed on a driving shaft or a driven shaft, wherein the pulley is provided with support surfaces for the drive belt, wherein the support surfaces are adjustable in radial distance to the centre line of the pulley.

73. Pulley according to claim 72, wherein the support surfaces are supported via first supports on support surfaces of second supports in the rest of the pulley, wherein the location of the effective support surfaces of the second supports is radially adjustable.

74. Pulley according to claim 73, provided with an adjustment part circulating with the pulley, which adjustment part can temporarily be given a speed deviating from the pulley speed in order to adjust the radial position of the support surfaces.

75. Endless belt for transmitting power from a driving shaft to a driven shaft, wherein the belt has a tensile reinforcement, such as tension cords or the like, wherein the portion of the belt that, considered in cross-section, is situated at the radial inside of the belt has a radial size that at the most equals the radial size of the portion of the belt that is situated at the other side of the tensile reinforcement, wherein the belt is provided with bevelled edges situated at the radial outside of the belt.

76. Vehicle comprising a drive according to claim 51, such as a bicycle.

77. Drive according to claim 57, wherein the balls or rollers are movable connected to each other and move according to an endless path.

78. Drive according to claim 57, wherein the balls or rollers are provided with at least one groove in the outer surface of the balls or rollers that corresponds with a ridge on the axial surface.

79. Drive according to claim 58, wherein the segments are provided with at least one groove in the outer surface of the segment that corresponds with a ridge on the axial surface.

80. Drive according to claim 65, comprising two radial disks and two spiral disks, wherein both the radial and the spiral disks are situated on both sides of the axial guides, wherein the two radial disks are connected to each other or mechanically coupled such that they co-rotate with each other and wherein the axial guides are moved radially due to rotation of the radial disks and the spiral-disks with respect to each other.

81. Drive according to claim 80, wherein the radial disks or the spiral disks are connected to the driven or the driving shaft of the pulley, wherein the axial guides are moved by decelerating the spiral disks or the radial disks while the shaft of the pulley is rotating.

82. Drive according to claim 80, wherein the radial disks and the spiral disks rotate such with respect to each other under spring force that the axial guides move in the direction of the largest diameter or the smallest diameter.

83. Drive according to claim 80, wherein the spiral disks and the radial disks can be mechanically coupled to each other with a controllable coupling.
